(19) United States
(12) Patent Application Publication
(10) Pub. No.: US 2017/0286449 A1
(43) Pub. Date: Oct. 5, 2017

(54) System for Connecting Computer Dashboards with Geographic Information Systems

(71) Applicant: US-ANALYTICS Solutions Group, LLC, Irving, TX (US)

(72) Inventors: Michael Strube, Irving, TX (US); Scott Preszler, Dallas, TX (US)

(73) Assignee: US-ANALYTICS Solutions Group, LLC, Irving, TX (US)

(21) Appl. No.: 15/088,541

(22) Filed: Apr. 1, 2016

(51) Int. Cl. G06F 17/30; G06F 3/0482

(52) U.S. Cl. CPC G06F 17/30241; G06F 17/30061; G06F 3/0482

(57) ABSTRACT

The present invention provides a connector system for incorporating geographic information system (GIS) data into a computer dashboard. The connector system comprises at least one map configuration file containing parameters for map elements and dashboard visual objects and a mapping module that visually renders a map within the dashboard using GIS data according to parameters in the configuration file. A translation module translates between a dashboard application programming interface (API) and a GIS API. Event listeners within the translation module monitor user selections of dashboard visual objects and GIS map objects that are cross-referenced with each other and updates both visual objects and map objects in response to a user selection of either. A communication module retrieves GIS data from at least one GIS data source according to instructions received from said translation module according to user selections and provides the GIS data to the mapping module.

### TECHNICAL FIELD

The present invention relates generally to computer dashboards, and more specifically to a system for integrating geographical information systems with dashboards.

### BACKGROUND OF THE INVENTION

A dashboard is a simple, real-time interface that provides a graphical presentation of present status or historical trends at a glance. It can be thought of as an easy to read, visual progress report. The dashboard is constantly updated by data sources such as remote or local databases, which allows the user to visualize and analyze large volumes of data to reveal patterns, trends, and relationships in a way that reports do not. Even if the data exists in many disparate places, streams, or web logs, it can be pulled together to help focus decision making.

Examples of uses for dashboards include tracking internal computer system performance (e.g., memory use, CPU use, internal temperature, etc.), organizational performance (e.g., sales, expenses, procurement, human resources, etc.), weather patterns, and geographical information.

Dashboards are the second generation of business intelligence. Twenty years ago, a spreadsheet was the only way to visualize data and attempt to see trends. Later, spreadsheet programs added graphs, charts, and reports. However, these could not be readily shared by multiple users. In the beginning, dashboards could not be shared either.

Today, the most common types of digital dashboards are stand-alone software applications, web-browser based applications, and desktop applications (aka “widgets”). Original dashboards were created and hosted in mainframe-based software, such as IBM-Cognos, SAP, or Business Objects. However, companies needed to get the information in front of a larger group of employees and decision makers. What was needed was the ability to use standard browsers over a network. Advancements in the World Wide Web and its associated display-focused scripting languages (HTML and HTML5) have allowed dashboards to be hosted in web servers and shared, through security, with many users.

One such web-based dashboard platform is Qlik®. Qlik® moved web-based, shareable dashboards even further by bringing all the data into the host server's RAM (random access memory). This increases the speed of processing and makes interacting with the dashboard instantaneous. Qlik® created self-serve analytics.

There are four major aspects of Qlik® dashboards which differentiate them from other dashboard products. First, by bringing all of the data into the RAM of the Qlik® server there is no network traffic back and forth to get query results, giving the dashboards their extreme processing speed. As such, the response is near instantaneous. Second, Qlik® has the ability to aggregate many data sources by using a “load script” that describes and performs all of the ETL (extract, transform, and load) functionality needed to bring in raw data and prepare it for visualization. Third is the associative capabilities of the data model. The Qlik® Associative Engine analyzes and associates all of the fields in all of the data sources designated by the load script. The data is reorganized and essentially inserted into a columnar database. The data is also compressed by a proprietary algorithm. This new structure, when used in-memory, provides the huge speed advantages over other products. Last is extensibility through third-party extension objects. All Qlik® products are architected to allow independent developers to create unique pieces of functionality which can be used by many applications/dashboards.

Every dashboard tool has the limitation that it cannot be designed so that out-of-the-box it can be connected to every possible third-party software, whether a database, a statistics package or a mapping environment. There are too many possibilities and too many advances in overall software development. Custom connectors are a normal requirement for advancing dashboard functionality. Some situations can be handled by common connectors, but there are scenarios that exist where a very specialized piece of software is needed to connect to Qlik®.

Qlik® products have been connected to many third-party products. For example, there is a custom connector for “R”, the statistical package. Social media is another area where a custom connector is required. The advanced nature of the application programming interface (API) which forms the code infrastructure for Qlik® provides a framework which can be accessed by developers to make these connectors.

Geographic Information Systems (GIS) are another example. GIS allows users to visualize, question, analyze, and interpret data to understand relationships, patterns, and trends. GIS benefits organizations of all sizes and in almost every industry and is the go-to technology for making better decisions about location. Common examples include real estate site selection, route/corridor selection, evacuation planning, conservation, natural resource extraction, etc. Making correct decisions about location is critical to the success of an organization. GIS is widely used to optimize maintenance schedules and daily fleet movements. Typical implementations can result in a savings of 10 to 30 percent in operational expenses through reduction in fuel use and staff time, improved customer service, and more efficient scheduling. As such, GIS is becoming essential to understanding what is happening and what will happen in geographic space. This new approach to management—managing geographically—is transforming the way organizations operate.

Esri® (Environmental Systems Research Institute) is a market and technology leader is GIS. Software firms from many fields want to connect with Esri® including logistics routing, demographic analysis, satellite imagery analysis, and pipeline construction, among others. In addition, Qlik® and other dashboard product providers want to connect or integrate with Esri®, but currently no such capability exists.

Therefore, it would be desirable to have a means and method for connecting and integrating GIS functionality with dashboard products.

### SUMMARY OF THE INVENTION

The present invention provides a connector system for incorporating geographic information system (GIS) data into a computer dashboard. The connector system comprises at least one map configuration file containing parameters for map elements and dashboard visual objects. It further comprises a mapping module that visually renders a map within the dashboard using GIS data according to parameters in the configuration file. A translation module translates between a dashboard application programming interface (API) and a GIS API. Event listeners within the translation module monitor user selections of dashboard visual objects and GIS map objects that are cross-referenced with each other. The translation module updates both visual objects and map objects in response to a user selection of either. A communication module retrieves GIS data from at least one GIS data source according to instructions received from the translation module in response to user selections and then provides the GIS data to the mapping module.

In response to a user selection of a dashboard visual object, the translation module updates the dashboard visual objects according to renderer values in the map configuration file. It then instructs the communication module to retrieve GIS data cross-referenced to the selected dashboard visual object and transfer that data to the mapping module for visualization in the dashboard. The translation module then translates from dashboard API to GIS API, allowing the mapping module to use renderer values to visualize points, lines, and polygons on the map according to said user selection.

In response to a user selection of a GIS map object, the mapping module reads parameters of the selection and sends unique map property identifiers to the translation module. The translation module then instructs the communication module to retrieve GIS data according to the map property identifiers and transfer the data to the mapping module. The translation module also translates from GIS API to dashboard API and updates dashboard visual objects according to renderer values cross-referenced to the selected map object. It also translates from the dashboard API to GIS API, allowing the mapping module to use renderer values to visualize points, lines, and polygons on the map according to said user selection.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1, a block diagram depicting the Qlik® dashboard system environment is shown in accordance with the prior art;

FIG. 1a is a pictorial depiction of an example Qlik® dashboard display;

FIG. 2 is a block diagram depicting the Esri® GIS system in accordance with the prior art;

FIG. 2a is a pictorial depiction of an Esri map creation area;

FIG. 3 is a block diagram illustrating a connector between the Qlik® and Esri® environments in accordance with the present invention;

FIG. 3a is a pictorial depiction of a dashboard created in the Qlik® environment and incorporating Esri® GIS features by means of a connector in accordance with the present invention;

FIG. 4 shows a more detailed view of a connector system in accordance with the present invention;

FIG. 5 illustrates the process by which user selections within the Qlik® environment interact with GIS objects in accordance with the present invention;

FIG. 6 depicts the process flow by which a user selection in a GIS mapping object interacts with the Qlik® environment in accordance with the present invention; and

FIG. 7 illustrates how the translation module manages user selections in the dashboard of either Qlik® or Esri® objects in accordance with the present invention.

### DETAILED DESCRIPTION OF THE DRAWINGS

To create an operational dashboard, a developer requires several key components. The first is data, which can be in, e.g. Excel, flat files or advanced databases like SQL Server, Oracle, Terradata or Hadoop. The data can also be geospatial and stored in Esri® in the form of map services. Data sources can run on independent servers located in the same data center or any other data center. Databases such as SQL Server or Access can run on the developer's machine. Simpler data sources like Excel or flat files could be located in a department repository or on the developer's machine.

The next components are the Key Performance Indicators (KPIs). These are the results to be visualized in the dashboard.

Third is a dashboard development tool. In the preferred embodiments of the present invention QlikView® or Qlik Sense® Desktop are used as the working environment to create the dashboard(s).

Last is a server such as QlikView® Server or Qlik Sense® Server, which is needed to provide web access for the dashboard. End users access the dashboard via standard browsers. The functionality that is used to create charts/graphs are generally out-of-the-box. If something unique is needed, QlikView® and Qlik Sense® have provided application programming interfaces (API's) to allow developers to customize new widgets.

In Qlik® terminology a connector is an “extension object” that extends the functionality of Qlik® products. Connectors are typically written using JavaScript. They create a code-based pathway between the API's for either QlikView® or Qlik Sense®. The API's are different in QlikView® and Qlik Sense®. Therefore, a connector created in QlikView® may provide the same functionality as a connector in Qlik Sense®, but they are not interchangeable.

Developers enhance the dashboard through the equations that describe the KPIs, the integration of an advanced database and the load script, and the security model which protects the data. The most difficult challenges involve connecting or integrating two or more distinct data sources. An example of this is connecting or bridging the Esri® (Environmental Systems Research Institute) mapping environment and Qlik®-based operational data, as taught by the present invention.

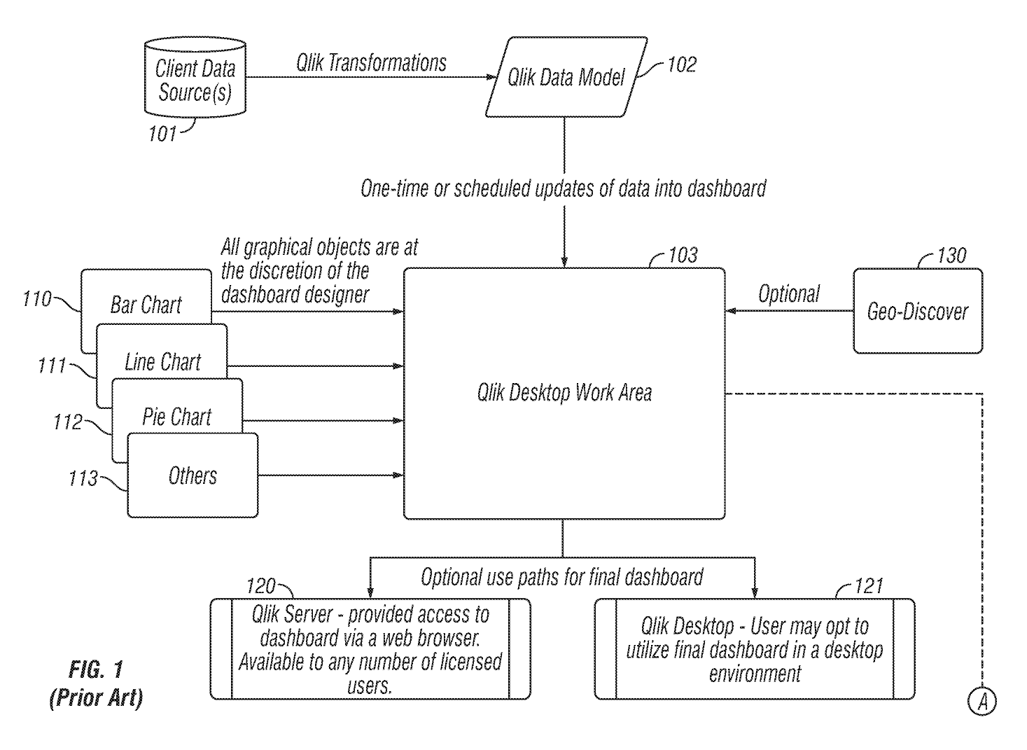

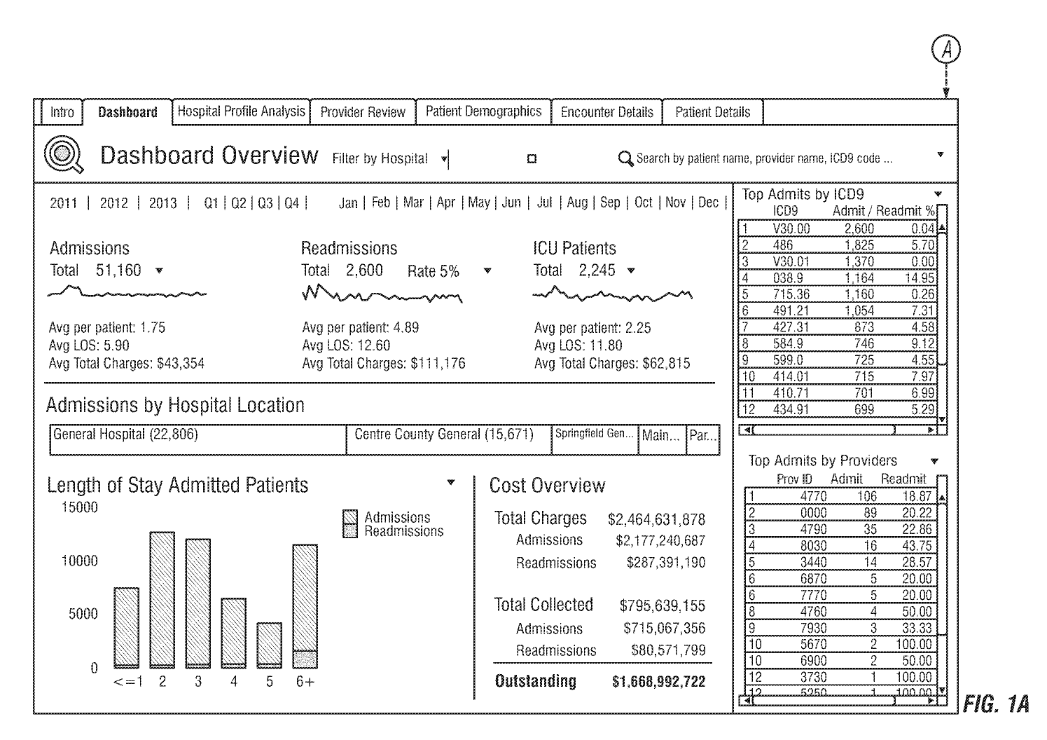

Referring now to FIG. 1, a block diagram depicting either a QlikView® or Qlik Sense® dashboard system environment is shown in accordance with the prior art. The dashboard is created by importing data from a client data source 101 into the Qlik® Data Model 102 using data transformations. Data transformations are necessary to convert data from disparate data sources into a more usable form in the new host database or data model. Transformations can be as simple as converting a date field from MM/DD/YYYY to DD/MM/YYYY, or the transformation can be a mathematical calculation performed on a field that is contained in every row of the original database table. The transformation can also be the concatenation of multiple field values into one newly formed field.

The data model 102 is also a columnar database, which holds all of the data from all of the data sources. The original relational database tables are converted into one columnar data model, while being compressed and indexed.

The data from the data model 102 is loaded into the dashboard 103. Figure la is a pictorial depiction of an example QlikView® dashboard display 103. Also loaded into the dashboard are various visual objects 110-113, which are chosen at the discretion of the dashboard designer. The visual objects 110-113 comprise the visual side of the dashboard and include, for example, bar charts, line charts, pie charts, as well as other potential tables, charts and widgets presented to the user, as shown by the example in Figure la. The combination of data model 102 and visual objects 110-113 creates a Qlik® dashboard environment.

Once the Qlik® dashboard has been populated it can be accessed through optional paths. One is a through a Qlik® Server 120, which provides access to the dashboard via a web browser to any number of licensed users. Alternatively, the dashboard can be accessed by the Qlik® Desktop 121, allowing a single user to access the final dashboard in a desktop environment.

In addition to the standard components described above, Qlik® also allows the use of optional connectors 130 that allow third parties to add functionality and content to the dashboard environment (explained in more detail below).

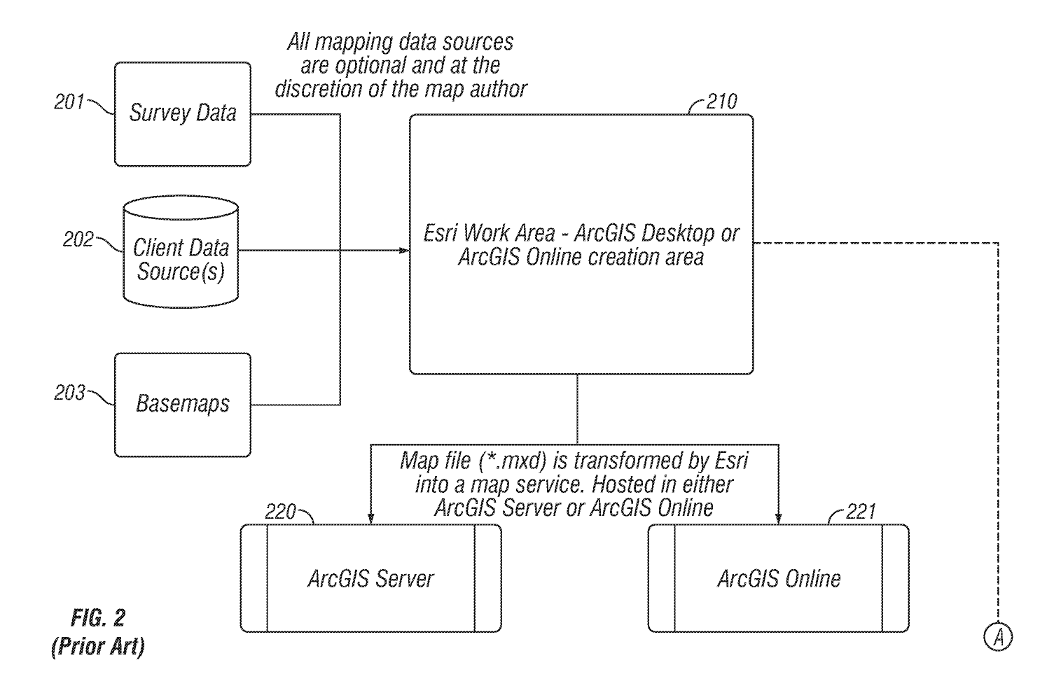

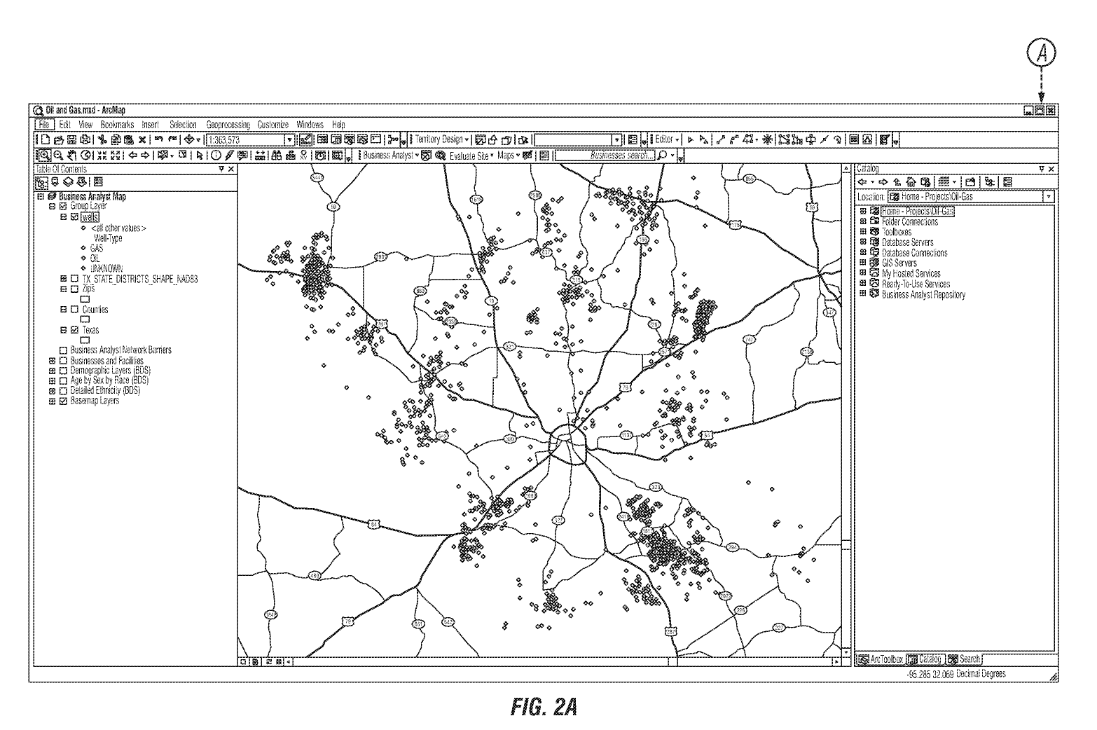

FIG. 2 is a block diagram depicting the Esri® GIS system in accordance with the prior art. The map is created by importing data from various sources such as, for example, third party survey data 201, client data sources 202, and basemaps 203. The mapping data sources used are optional and at the discretion of the map's author.

The data is imported into the Esri® Work Area 210, which is created with either ArcGIS Desktop or ArcGIS Online. ArcGIS is a software platform that allows surveyors, civil engineers, city engineers and many others to create maps. The items or locations that are depicted on the map also have attributes, which are also included in the map's attributes. It is stored in a unique file format created by Esri®. Over the last 45 years, the Esri® formats have become the international standard for storing GIS data and maps. FIG. 2a is a pictorial depiction of an Esri® map creation area 210.

The map file (*.mxd) created in the work area 210 is transformed by Esri® into a map service, which is hosted either in ArcGIS Servers 220 or ArcGIS Online 221. The ArcGIS Server was created to allow the sharing of data and maps and has also evolved to be the web-publishing arm, allowing maps to be shared over the Internet. The map services are the most common format for sharing maps and their attributes. The present invention utilizes such map services to bring maps into Qlik® dashboards.

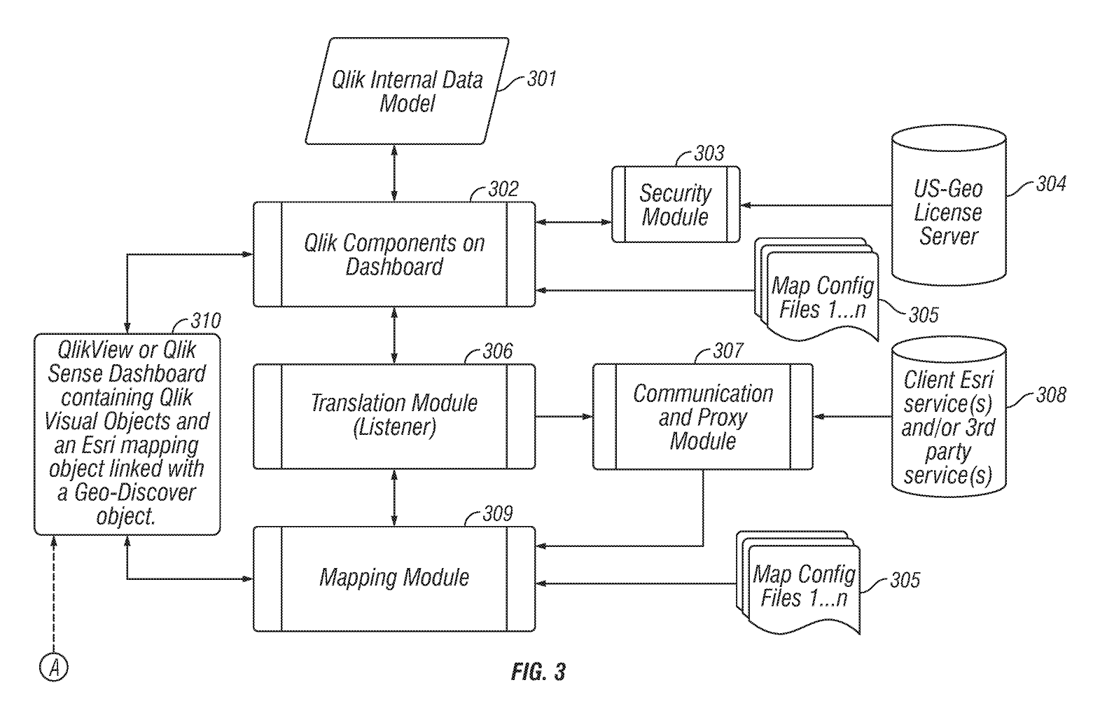

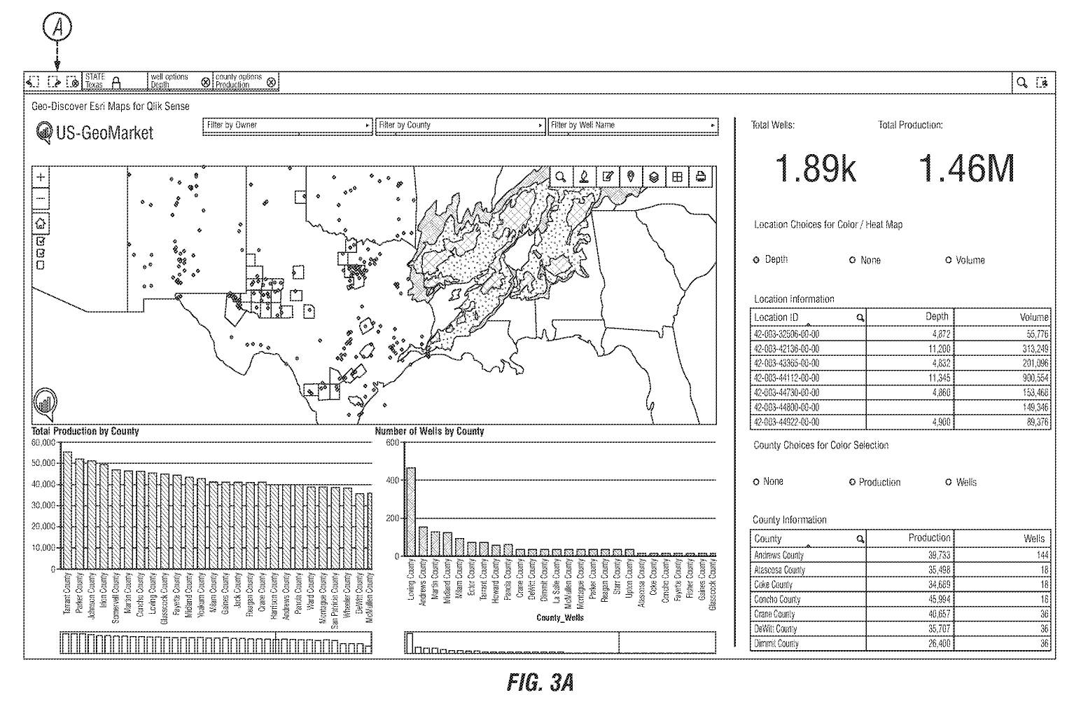

FIG. 3 is a block diagram illustrating a connector between the Qlik® and Esri® environments in accordance with the present invention. The first step is to bring the various client data sources into the Qlik® internal data model 301 as explained above. The type of data will depend on the industry involved. For example, the oil and gas industry might use pipeline metrics, repair records, personnel, and sensor data. Retail operations might include client information, loyalty programs, inventory, pricing, costs, real estate, and remodel dates. Examples in healthcare include patient information, diagnostic codes, procedures, insurance info, and statistics. An insurance company might include polices, weather history (e.g., tornados, hurricanes, floods, etc.), and risk factors. Examples for cities include infrastructure, crime, etc. Just about any type of organization has it own particular categories of data, many of which can be evaluated based on geographic distribution.

The combination of data model 301 and visual objects 302 creates a Qlik® dashboard 310. A mentioned above, the dashboard consists of multiple objects, which might include, e.g., line charts, bar charts, pie charts, tables, and/or a mapping object. The visual objects are connected via the Associative Engine of Qlik®, which are the built-in filters. For example, if a user picks “Texas” from the list of states in a list box, the bar charts automatically filter to only “Texas” data. Everything is connected, synchronized and associated.

One predefined attribute of the mapping object is a reference to a specific map configuration file 305. This is a javascript file containing all of the definition parameters particular to the client's Esri® map service that bring together the individual components that make a map in the Qlik® dashboard 310. One embodiment of the present invention uses the Property Windows built into the Qlik® products. The present invention modifies these Property Windows to accept all of the configuration parameters. This information is then automatically transferred to the javascript file.

The following are examples of parameters that can be repeated for every layer the client system brings into the map object:
Client's map service uniform resource locator (URL);
Visible or not by default—whether a layer appears on start-up;
Selectable or not by default—whether a layer is available for picking in the dropdown list of layers;
Associated field—the Qlik® field name and its corresponding Esri® field name, which is how the translation module connects Qlik® data to Esri® map data;
Zip and ZipCode or PlantID and P_ID—allows the map to be bi-directional, allowing changes in the dashboard and the map to synchronize.
Pop-up parameters:
   Qlik® table name with columns to be displayed in the pop-up;
   Column name of data desired in the pop-up;
   Esri® field names desired in the pop-up;
Renderer (coloring):
   Qlik® table name with column of the color desired in the map on the corresponding item (i.e. county, zip, point);
   For a dynamic balloon on a point, the largest and smallest size of the ball, based on a value in the table (above);
Renderer for heatmap:
   Qlik® table name with columns to be displayed in the heatmap;
   Column name of data to be in the heatmap;
   Esri® field names desired in the heatmap;
Basemaps:
   Ability to create a custom basemap (e.g., sales territory, county that make up a congressional district);
   Select the basemap desired as the default.

When the end-user launches the dashboard the predefined attribute that defines the separate map configuration file 305 causes the related file to be accessed, and all of the parameters defining the map are loaded into the dashboard mapping object, thereby preparing the dashboard for the map. The map configuration file 305 also contains a username and password, which verifies that the mapping object is properly authenticated.

This security information is transmitted through a security module 303 to the license server 304. This username/password combination is compared to the security file stored in the license server 304 to confirm that the Qlik-to-Esri® connector is valid. If it is validated the map object will finish visualizing the map and the map's associated data. The license manager module 304 may be remote to the client site or it might be on the client's site.

The visual objects in the dashboard 302 interact with a translation module 306 that in turn interacts via a communication and proxy module 307 with a third party database 308 such as an Esri® GIS map service database. GIS information from the database 308 is used in conjunction with associated map configuration files 305 by the mapping module 309 to render the map within the Qlik® dashboard 310. FIG. 3a is a pictorial depiction of a dashboard created in the Qlik® environment and incorporating Esri® GIS features by means of a connector in accordance with the present invention.

The Translations Module 306 utilizes “event listeners” (monitoring algorithms) designed specifically for monitoring either Qlik® APIs or Esri® APIs. The function of an event listener is to monitor for and react to changes created by user input. Some of the event listeners are assigned to specific list boxes in the Qlik® visual objects. Other event listeners are assigned to Esri® attributes via Esri® APIs to detect changes. In this manner the translation module 306 is divided into a Qlik® (dashboard) channel and a Esri® (GIS) channel. During the process of receiving a change in the Qlik® environment the dataset message is monitored and received in the Qlik® channel, and the translation module reconfigures (translates) the message for consumption by the Esri® APIs and feeds the message into the Esri® channel. The reverse process occurs in response to a change in the Esri® environment.

For example, in the QlikView® dashboard environment the translation module 306 uses the QlikView® API to communicate with an object via its object identifier (OID) provided in the configuration for that layer of the map. It then binds a custom function to the SetOnUpdateComplete event method from the QlikView® or Qlik Sense® API, which triggers every time the user changes the selection either directly or indirectly (by making a selection in another object), e.g., by selecting “Oklahoma” instead of “Texas” from the dashboard choices.

The translation module 306 listens to every request made to the dashboard. For example, the user might click in the dashboard to make a selection, such as a state, e.g. “Texas.” When the translation module 306 detects a change in Qlik® from user input it translates it into a form that Esri® understands. It then transfers a data representation (STATE ID) of “Texas” to the Esri® map services over the Esri® APIs and/or the Qlik® APIs (explained in more detail below). The map services respond and send Esri® data concerning “Texas” back to the connector using the Esri® APIs. The connector then translates that data via the mapping module 309 into a form that QlikView® or Qlik Sense® can use to update the visualizations in the dashboard 310.

Alternatively, the translation module 306 listens to Esri®, and if it detects a selection being made in the map, it instructs the appropriate Qlik® list boxes to match. This drives the Qlik® Associative Engine to synchronize and filter all the Qlik® visual objects, which then updates the visualizations in the dashboard 310.

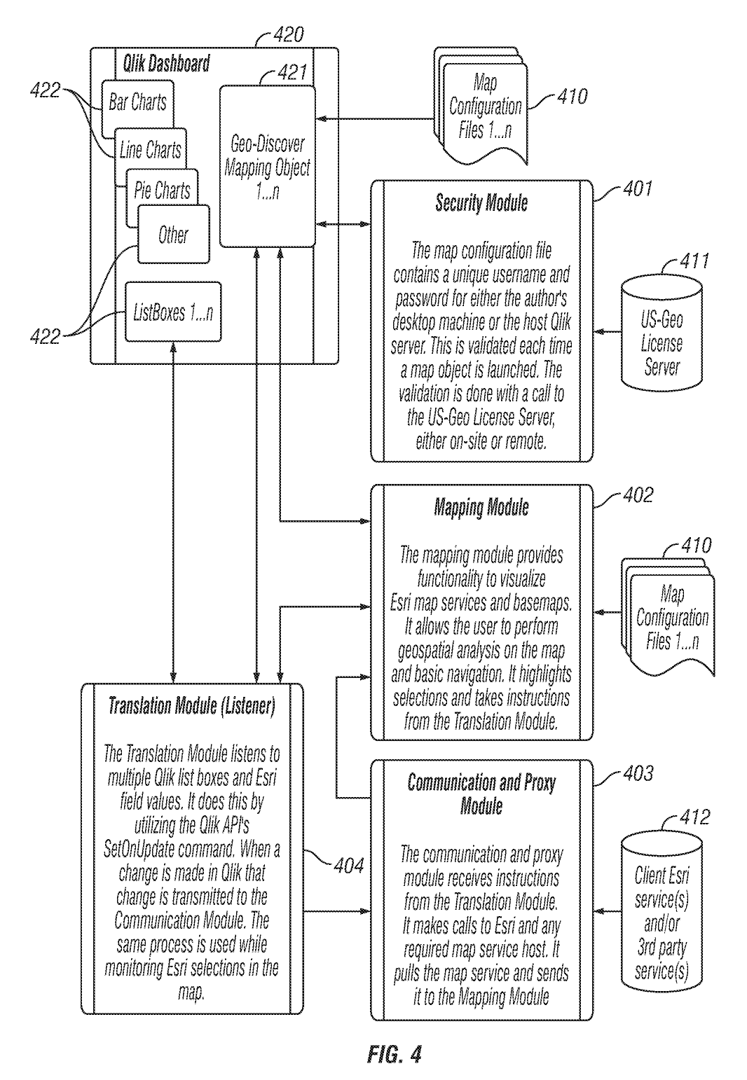

FIG. 4 shows a more detailed view of a connector system in accordance with the present invention. As mentioned above, the security module 401 mediates between the license server 411 and the mapping object 421 in the dashboard 420. The map configuration files 410 used by the dashboard 420 contain a unique username and password for either the author's desktop machine or the host Qlik® server. This security information is validated each time a map object 421 is launched in the dashboard 420.

The mapping module 402 provides functionality to visualize Esri® map services and basemaps in the mapping object 421 of the dashboard. Using the map configuration files 410, the mapping module 402 allows the user to perform geospatial analysis on the map and basic map navigation. It highlights selections in the mapping object 421 and takes instructions from the translation module 404.

The communication and proxy module 403 receives instructions from the translation module 404 and in turn sends data requests to the Esri® database 412 and any other required map services host. The communication module 403 receives map service data back from the Esri® database 412 and sends it to the mapping module 402.

The translation module 404 monitors mutiple Qlik® list boxes 422 and Esri® field values in the map object 421. In the Qlik Sense® environment the translation module 404 uses the Qlik® API to create an in-memory list (using createList) for the field/dimension and binds a custom function that is called every time the data in the list is updated (returning the selection state of every item in the list). When a change is made in Qlik Sense® that change is transmitted to the communication module 403.

A similar process is used while monitoring Esri® selections in the map 421. The translation module 404 uses the Esri® JavaScript API to make selections and hook into the ‘draw-end’ event to start the process of applying the spatial query to the selected feature layer. It uses the resulting feature set to create a selection set to apply to either the associated Qlik® object in QlikView® or the field/dimension in Qlik Sense® using the respective API.

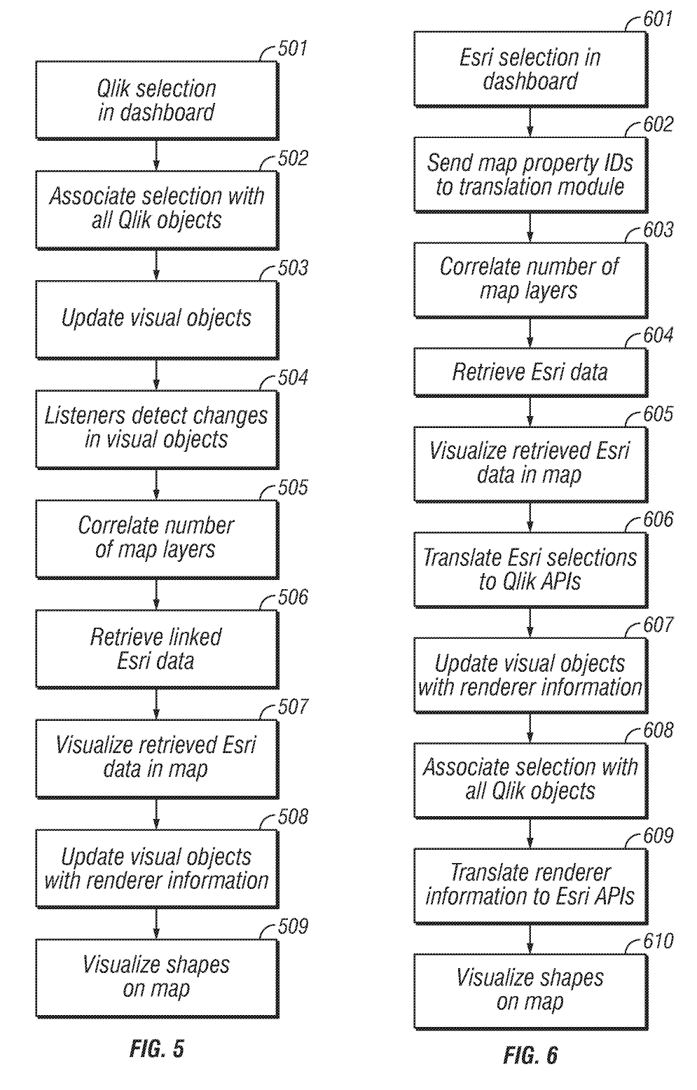

FIG. 5 illustrates the process by which user selections within the Qlik® environment interact with GIS data in accordance with the present invention. The process begins with the user making a selection in the dashboard (step 501). This could be, for example, in a list box, chart, table, or any Qlik® visual object. The map configuration file instructs the translation module to listen to specific visual objects for changes. In response to the selection, the associative engine associates the selection with all other Qlik® objects (step 502) and updates those objects (step 503). The Qlik® associative engine causes all list boxes in the dashboard to be updated if even one list box is changed.

Event listeners in the translation module detect the changes in the visual objects (step 504). These visual objects are linked (cross-referenced) to key Esri® attributes. The mapping module correlates the number of layers in the map (step 505). The layers are defined in the map configuration file and identified by unique number.

The communication module then retrieves Esri® information related to the newly selected objects by making calls to remote Esri® servers to obtain the map service that contains the mapping information for the layer (step 506) and then transfers the data to the mapping module for visualizing in the map (step 507).

Pop-up definitions and renderer information for the specified layers retrieved from the map configuration files are used to update the Qlik® visual objects (step 508). The various renderers push the pre-defined colors into the polygons represented on the map, e.g., color-coding counties.

The translation module translates between the Esri® and Qlik® APIs, allowing the mapping module to then use renderer values to visualize points, lines, and polygons on the map, highlighting with renderers the Qlik® Green/While/Gray selections to update the dashboard display (step 509).

Steps 502-509 are repeated for each interaction with the Qlik® dashboard objects.

FIG. 6 depicts the process flow by which a user selection in a GIS mapping object interacts with the Qlik® environment in accordance with the present invention. The user makes an Esri®-based selection in the dashboard (step 601). This can be done with any Esri® tool such as, e.g., rectangular, circular, freeform, polygon, and all other Esri®-based selection functionality, which are defined in the mapping module. The mapping module reads the parameters of the selection and sends unique map property IDs to the translation module (step 602).

Event listeners in the translation module are focused on key Esri® objects. These Esri® objects are linked to key Qlik® attributes or fields. In response to the selection, the mapping module determines how many layers there are in the map (step 603), and the communication module retrieves the Esri® information related to the newly selected object(s) from the Esri® server (step 604) and transfers the data to the mapping module for visualizing in the map (step 605).

The translation module communicates all changes in Esri® selections and parameters to a form understood by Qlik® APIs (step 606).

Pop-up definitions and renderer information for the specified layers retrieved from the map configuration files are then used to update the visual objects (step 607). After the visual objects are updated, the Qlik® associative engine associates the selection with all other Qlik® objects and updates all Qlik® objects (step 608).

Next, the translation module takes the renderer values, pop-up, and other parameters from Qlik® and translates them to the Esri® APIs (step 609).

The mapping module is then able to use the render values to visualize points, lines, and polygons on the map, highlighting with renderers the Qlik® Green/While/Gray selections to update the dashboard display (step 610).

Steps 602-609 are repeated for each interaction with an Esri® map object.

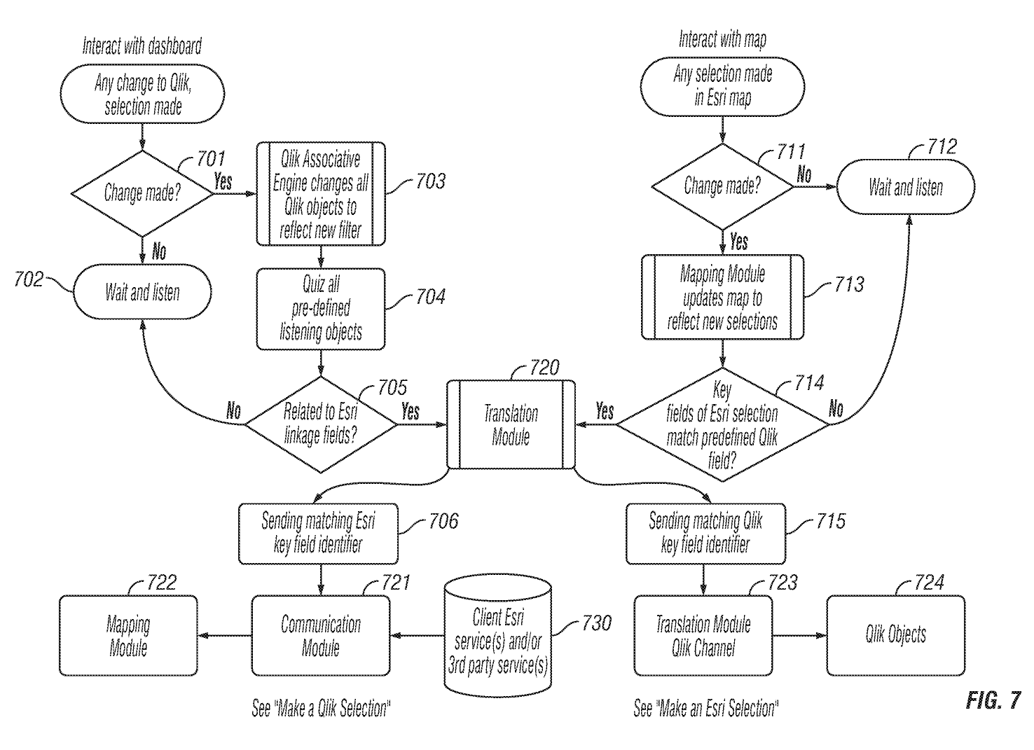

FIG. 7 illustrates how the translation module manages user selections in the dashboard of either Qlik® or Esri® objects in accordance with the present invention. In the case of user interaction with the dashboard, listeners in the translation module 720 continually monitor the Qlik® dashboard for changes from a user selection and determine if any such change has occurred (step 701). If no change is detected, the event listeners wait and continue monitoring (step 702). If a change is detected, the Qlik® associative engine changes all Qlik® objects to reflect the new filter (step 704).

After the Qlik® objects are updated, the translation module 720 quizzes all pre-defined event listening objects (step 704) and determines if any of them are related to Esri® linkage fields (step 705). If none of them are related to Esri®, the event listeners go back into wait and listen mode (step 702).

If any of the pre-defined event listening objects are related to Esri® linkage fields, the translation module 720 sends the matching Esri® key field identifier(s) to the communications module 721 (step 706). The communication module 721 then retrieves the Esri® data from the Esri® map services 730 and supplies to the mapping module 722 to update the mapping object as explained above.

For Esri® selections in the map, event listeners in the translation module 720 continually monitor the dashboard for any user selection made in the Esri® map and determine if a change has been made (step 711). If no change is detected, the event listeners wait and continue monitoring (step 712). If a selection is made in the Esri® map the mapping module updates the map to reflect the new selections (step 713).

The translation module 720 then determines if any of the selected key fields of the Esri® selection match predefined Qlik® fields (step 714). If none match, the listeners go back into wait and listen mode (step 713).

If any of the Esri® fields do match predefined Qlik® fields, the translation module 720 sends matching Qlik® key field identifiers to the Qlik® channel 723 of the translation module (step 715), which then updates the Qlik® objects 724.

It will be appreciated by those of skill in the art that the elements comprising the present invention can be implemented in either hardware or software, or a combination of both. It is well known in the art that hardware circuits and software code are logically equivalent. As summarized by Andrew S. Tanenbaum, “Any operation performed by software can also be built directly into the hardware...the reverse is also true: any instruction executed by the hardware can also be simulated in software,” (Structured Computer Organization, 5^{th} Ed., Prentice Hall, 2006, p. 8).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim:

1. A connector system for incorporating geographic information system (GIS) data into a computer dashboard, the connector system comprising:
(a) at least one map configuration file containing parameters for map elements and dashboard visual objects;
(b) a mapping module that visually renders a map within said dashboard using GIS data according to said parameters in the map configuration file;
(c) a translation module that translates between a dashboard application programming interface (API) and a GIS API, wherein event listeners within the translation module monitor user selections of dashboard visual objects and GIS map objects, wherein dashboard visual objects are cross-referenced with GIS map objects in the mapping configuration file, and wherein the translation module updates cross-referenced dashboard visual objects and map objects in response to a user selection of either; and
(d) a communication module that retrieves GIS data from at least one GIS data source according to instructions received from said translation module according to user selections and provides said GIS data to the mapping module.

2. The connector system according to claim 1, wherein in response to a user selection of a dashboard visual object, the translation module:
(i) updates dashboard visual objects according to renderer values in the map configuration file;
(ii) instructs the communication module to retrieve GIS data cross-referenced to the selected dashboard visual object and transfer said GIS data to the mapping module for visualization in the dashboard; and
(iii) translates from dashboard API to GIS API, allowing the mapping module to use renderer values to visualize points, lines, and polygons on the map according to said user selection.

3. The connector system according to claim 1, wherein in response to a user selection of a GIS map object, the mapping module reads parameters of the selection and sends unique map property identifiers to the translation module, where the translation module:
(i) instructs the communication module to retrieve GIS data according to said map property identifiers and transfer said GIS data to the mapping module for visualization in the dashboard;
(ii) translates from GIS API to dashboard API and updates dashboard visual objects according to renderer values cross-referenced to the selected map object in the map configuration file; and
(iii) translates from the dashboard API to GIS API, allowing the mapping module to use renderer values to visualize points, lines, and polygons on the map according to said user selection.

4. The connector system according to claim 1, further comprising a security module for verifying user credentials before allowing said map object to load into said dashboard.

5. The connector system according to claim 1, wherein the mapping module correlates a number of map layers specified in the map configuration file, and the communication module retrieves GIS data for each such layer.

6. The connector system according to claim 1, wherein at least one of the elements of the system is implemented in hardware.

7. The connector system according to claim 1, where at least one of the elements of the system is implemented in software.
